(19) United States
(12) Patent Application Publication
(10) Pub. No.: US 2019/0013555 A1
(43) Pub. Date: Jan. 10, 2019

(54) Heating Panel

(71) Applicant: ILLINOIS TOOL WORKS INC., Glenview, IL (US)

(72) Inventor: Edward F. Bulgajewski, Genoa, IL (US)

(21) Appl. No.: 15/747,036

(22) PCT Filed: Jul. 25, 2016
(86) PCT No.: PCT/US2016/043881

§ 371 Date: Jan. 23, 2018

Related U.S. Application Data
(60) Provisional application No. 62/199,581, filed on Jul. 31, 2015.

(51) Int. Cl. H01M 10/615; H01M 10/637; H01M 10/655; H01M 10/6571

(52) U.S. Cl. CPC H01M 10/615; H01M 10/637; H01M 10/655; H05B 2203/02; H05B 2203/003; H05B 2203/005; H05B 2203/013; H01M 10/6571

(57) ABSTRACT

A flexible heater for electrochemical batteries, for example, in automotive applications, may be attached directly to pouch cells of the batteries for rapid direct heating. High-voltage operation compatible with electric vehicles is provided by separating the positive temperature coefficient heating material with longitudinally extending moats that corral current to flow primarily in the longitudinal direction reducing a tendency of hotspot development in such material.

### CROSS REFERENCE TO RELATED APPLICATIONS

The present application claims the benefit of U.S. provisional application 62/199,581 filed Jul. 31, 2015, and hereby incorporated in its entirety by reference

### FIELD OF THE INVENTION

The present invention relates to electrical heaters and in particular to a thick film polymer electrical heater suitable for use with high voltages.

### BACKGROUND OF THE INVENTION

Electric vehicles and hybrid electric vehicles make use of batteries for energy storage. In this application, the batteries may be subject to a range of storage temperatures including subzero temperatures. At low temperatures, the available power for many types of batteries, including lithium ion batteries, is substantially reduced and the battery efficiency decreased.

Co-pending U.S. patent application 61/977,802, filed Apr. 10, 2014, assigned to the present assignee and hereby incorporated by reference, describes a heater for electric vehicle batteries in the form of a flexible substrate having a “thick film” polymer positive temperature coefficient (PTC) material on the substrate overlaid with interdigitated conductive electrodes. The electrodes can be used to apply current through the positive temperature coefficient material providing a flexible heater unit that may be closely integrated with the batteries to provide for warming of the batteries at cold temperatures.

Such flexible heaters are normally used at relatively low voltages, for example, less than 100 volts; however, higher operating voltages may be desirable in automotive applications for compatibility with electric vehicle power systems which operate at higher voltages and in order to reduce wiring cost and weight by reducing the amount of current flow for a given amount of power.

### SUMMARY OF THE INVENTION

The present inventors have determined that standard thick film polymer heater designs, when operated at high voltages (e.g., 330 volts DC to 1000 volts DC), can exhibit extreme non-homogeneity in current distributions creating hotspots and potential risk of premature failure. This uneven current flow occurs despite the natural current regulating properties of PTC material.

The present invention addresses this problem of high-voltage non-uniform current density by creating a set of current-isolating “moats” within the PTC material that enforces parallel current flow without convergence. In some embodiments, the insulating channels are bridged periodically by floating buses that serve to restore uniform current flow through the isolated portions of the PTC material. The result is a flexible thick film polymer heater capable of operating at higher voltages with improved temperature uniformity.

Specifically, in one embodiment, the invention provides a heater panel for a battery having a flexible polymer substrate and conductive electrodes communicating between heater terminals and electrode fingers spaced apart along a longitudinal axis. A positive temperature coefficient material having a higher resistance than the conductive electrodes electrically interconnects and extends between the electrode fingers. The positive temperature coefficient material has a plurality of insulating moats blocking current flow through the positive temperature coefficient material across the moats, the moats positioned and sized to favor the flow of electrical current along the longitudinal axis through the positive temperature coefficient material in comparison to electrical current flow perpendicular to the longitudinal axis through the positive temperature coefficient material.

It is thus a feature of at least one embodiment of the invention to provide for a high-efficiency cell heater for automotive applications and the like that may make use of available high-voltage electricity while minimizing the development of hotspots.

The moats may be gaps in the positive temperature coefficient material having a longitudinal length measured along the longitudinal axis at least five times greater than a transverse height of the moats measured perpendicularly to the longitudinal axis.

It is thus a feature of at least one embodiment of the invention to flexibly steer the electrical current in a preferred direction by strategically placed insulating gaps.

The moats may extend continuously between flanking pairs of electrode fingers.

It is thus a feature of at least one embodiment of the invention to fully segregate current flow through the positive temperature coefficient material into a set of independent longitudinal channels.

The moats follow a serpentine path along the longitudinal axis.

It is thus a feature of at least one embodiment of the invention to reduce the effect of local transverse variations in the PTC material by varying the transverse path of current flow.

The heater panel may further include floating electrodes extending transversely across the positive temperature coefficient material in a transverse range in which portions of the positive temperature coefficient material are separated by moats.

It is thus a feature of at least one embodiment of the invention to permit transverse readjustment and re-equalization of current flows without the generation of hotspots by providing low resistance transverse floating electrode conductors.

The floating electrodes may bridge at least one moat.

It is thus a feature of at least one embodiment of the invention to provide a simple construction that eliminates hotspot development in the event of connection failure between the floating electrodes and the PTC material.

The positive temperature coefficient material may be a conductive ink.

It is thus a feature of at least one embodiment of the invention to provide a method of accommodating thick film PTC material that may exhibit some process variations exacerbated by high-voltage operation.

The conductive electrodes may be a conductive ink having a lower resistance than the positive temperature coefficient material.

It is thus a feature of at least one embodiment of the invention to provide a simple printing process for fabricating the heater panel.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an exploded perspective view of a pouch cell having an integrated heater element attached to the cell wall according to the present invention;

FIG. 2 is a top plan view of a simplified prior art flexible film heater showing a PTC material overlaid with interdigitated conducting electrodes and also showing a fragmentary cross-section of the different layers of the flexible film heater;

FIG. 3 is a simplified representation of an experimentally obtained thermographic depiction of the PTC material for the flexible film heater of FIG. 2 operated at low voltage and showing uniform and constrained heating between conducting electrodes;

FIG. 4 is a figure similar to that of FIG. 3 showing operation of the flexible film heater of FIG. 2 at 300 volts and the occurrence of an “M”-shape heating pattern representative of a disruption in current distribution such as may create hotspots;

FIG. 5 is a view similar to that of FIG. 2 of a first embodiment of the present invention incorporating non-rectilinear current-parallel isolating moats within the PTC material for enforcing more uniform current flow at high voltages;

FIG. 6 is a figure similar to that of FIGS. 2 and 5 showing an alternative embodiment using staggered, current-parallel isolating moats together with floating bus bars to promote current uniformity;

FIG. 7 is a fragmentary view of an alternative embodiment to FIG. 6 in which the PTC material between floating bus bars remains aligned and is not staggered;

FIG. 8 is a fragmentary view of an alternate embodiment of FIG. 5 showing an alternate pattern for the non-rectilinear current-parallel isolating moats; and

FIG. 9 is a fragmentary view of an alternative embodiment of FIG. 6 showing the use of floating bus bars that cross a limited number of current-isolating moats.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

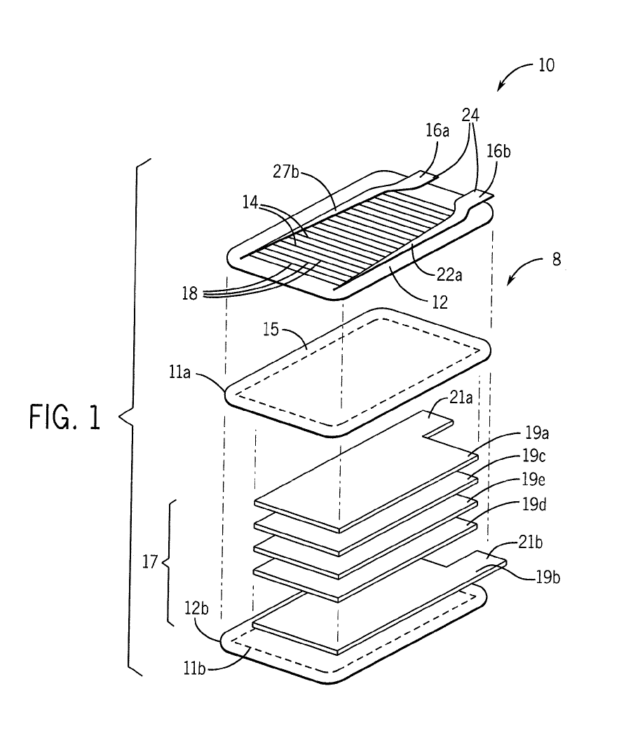

Referring now to FIG. 1, a pouch cell 8, suitable for assembly into a battery for use in an electric vehicle such as a car or the like, may have a generally flattened prismatic form factor having upper and lower rectangular pouch walls 11a and 11b. The upper and lower rectangular pouch walls 11a and 11b will typically be constructed of a flexible, insulating polymer sheet that may be heat sealable around a seam periphery 15 to provide a pouch defining an enclosed volume 17.

The enclosed volume 17 may hold various plates, separators, and electrolytes selected to provide electrochemical storage and release electrical power. Specifically, the volume 17 may hold an upper current collector plate 19a such as a metal foil or other conductor having a plate area to fit within the volume 17 and an extending tab electrode 21a to project beyond the seam periphery 15 of the upper and lower rectangular pouch walls 11a and 11b for external connection to the upper current collector plate 19a. The upper current collector plate 19a will be positioned adjacent to the upper rectangular pouch wall 11a.

A similar, lower collector plate 19b may be positioned adjacent to the lower rectangular pouch wall 11b and may likewise have a plate area fitting within the volume 17 and tab electrode 21b projecting beyond the seam periphery 15 and displaced from the tab electrode 21a, for example, on opposite left and right sides of one edge of the seam periphery 15.

The upper and lower collector plates 19a and 19b may flank a stack comprising a negative electrode material 19c adjacent to the upper current collector plate 19a, a positive electrode material 19d adjacent to the lower current collector plate 19b, and a separator 19e between the negative electrode material 19c and the positive electrode material 19d. Generally an individual pouch cell 10 will hold a single positive electrode material 19d and negative electrode material 19c.

Construction of a pouch cell as described above may be according to the description of US patent application 2012/0263987 entitled “High-Energy Lithium-Ion Secondary Batteries” assigned to Envia Systems, Inc., and hereby incorporated by reference.

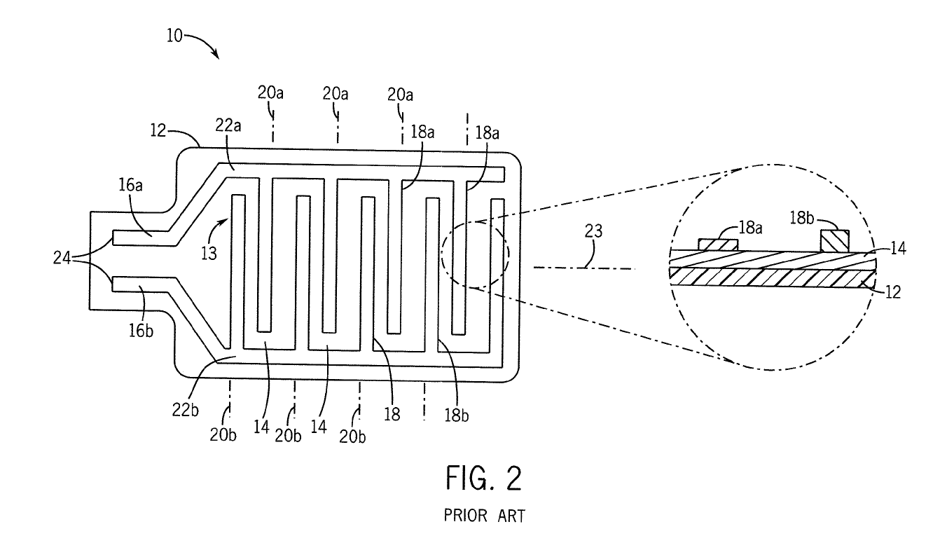

Referring now to FIGS. 1 and 2, a prior art, thick film polymer heater 10 may provide a flexible substrate 12 providing a substantially nonconductive polymer sheet. An example substrate 12 may be a seven mil polyester material.

A heating area 13 on the upper broad surface of the flexible substrate 12 (in this example, a rectangular region) may be coated with a substantially continuous thick film of positive temperature coefficient (PTC) material 14. A positive temperature coefficient of resistance causes the amount of electrical flow to vary according to the temperature of the material, with increased electrical flow at lower temperatures and decreased electrical flow at higher temperatures typically following a substantially nonlinear pattern as a function of temperature. This property provides for a self-regulating temperature of the PTC material 14 when a substantially constant voltage source is applied across the PTC material 14.

In one embodiment, the PTC material 14 may be a conductive polyester material exhibiting a rising resistance with temperature to provide for a temperature-driven current limiting effect. The natural current limiting of this PTC material 14 would be expected to reduce hotspots in the thick film polymer heater 10 by increasing the resistance of areas having excess current flow.

The heating area 13 of the flexible substrate 12 may be coated with the PTC material 14 by a variety of techniques including, for example, the application of a conductive ink using screen-printing or the like. Positive temperature coefficient (PTC) heaters, suitable for the present invention, are also disclosed in U.S. Pat. Nos. 4,857,711 and 4,931,627 to Leslie M. Watts hereby incorporated in their entireties by reference.

A positive electrode array 16a and negative electrode array 16b, both formed of a conductive material may be printed using a conductive ink or otherwise applied to the upper surface of the PTC material 14 to communicate electrically therewith. These electrode arrays 16a and 16b may be connected across a source of electrical power 40, for example, high-voltage DC or pulse width modulated DC at a voltage above 50 volts associated with the automotive electrical system.

The positive electrode array 16a may have fingers 18a extending over the surface of the PTC material 14 in a first direction along equally spaced parallel axes 20a. These fingers 18a may electrically communicate with a bus conductor 22a running generally perpendicularly to the axes 20a along one edge of the PTC material 14.

Negative electrode array 16b may have fingers 18b extending over the surface of the PTC material 14 in a second direction opposite to the direction of the fingers 18a and interdigitated with fingers 18a. These fingers 18b may also extend along regular parallel axes 20b positioned evenly between and parallel to the axes 20a. Fingers 18b may join to bus conductor 22b running generally perpendicularly to the axes 20b at an edge of the PTC material 14 opposite that of bus conductor 22a.

Bus conductors 22a and 22b may extend to one end of the substrate 12 to present connection terminals 24 to which DC power or pulse width modulated power may be applied. When power is applied to the terminals 24, current will generally flow through the PTC material 14 between fingers 18a and 18b in a longitudinal current flow axis 23 direction generally perpendicular to the axes 20.

The conductive material of the electrode arrays 16, fingers 18, and terminals 24 may be, for example, a conductive polymer such as compounded from a polymer base having a fine particulate filler of conductive material, such as silver, generally providing a much lower resistance than the PTC material for a comparable cross-section.

An example thick film polymer heater 10 may provide, for example, for 24 watts of power over an area of approximately 4 by 6 inches or about one watt per square inch to provide a target temperature range of 55 to 65 degrees centigrade at room temperature. A total resistance between terminals 24 may be on the order of 5-10 K ohms at ambient temperature.

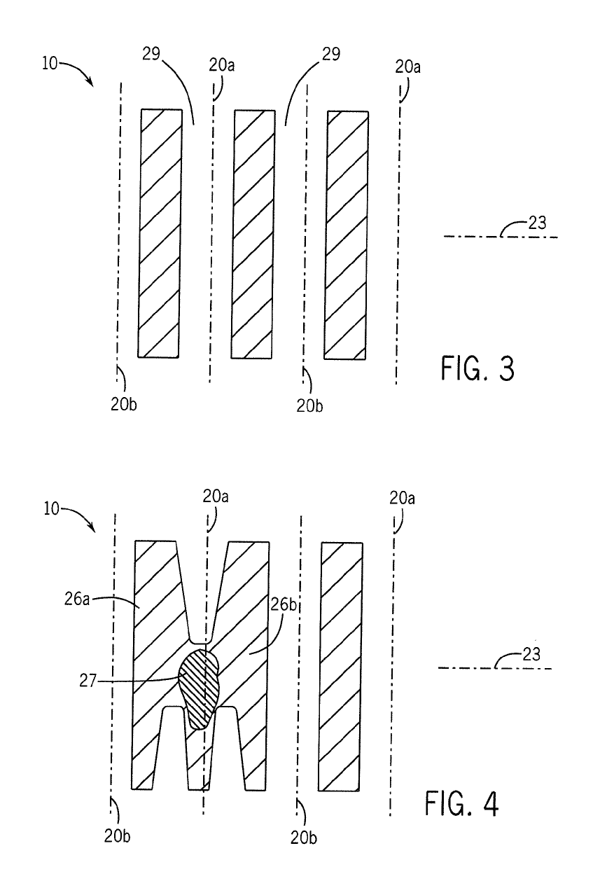

Referring now to FIG. 3, when the thick film polymer heater 10 of FIG. 2 is operated at a relatively low voltage, for example, 12 volts, regular rectangular heating areas 26 of substantially uniform but elevated temperature will form between the axes 20a and 20b. This uniform temperature of heating areas 26 reflects a substantially even current flow in those regions along the longitudinal current flow axis 23 between fingers 18.

The rectangular heating areas 26 are separated by narrow cool zones 29 aligned with the axes 20 at the location of the fingers 18 (shown in FIG. 2). These cool zones 29 result from a shunting of current out of the PTC material 14 into the fingers 18 as current seeks a path of lowest resistance.

Referring now to FIG. 4, when the thick film polymer heater 10 of FIG. 2 is operated at a high-voltage, for example, 300 volts, adjacent rectangular heating areas (e.g., 26a and 26b) may merge across an axis 20 indicating a disruption in the expected regular current distribution. This disruption steals current from the upper ends of the heating areas 26a and 26b diverting it to a hotspot location 27 hotter than the other areas of the heating areas 26 beneath fingers of the axis 20 and adversely affects the uniformity of heat provided by thick film polymer heater 10.

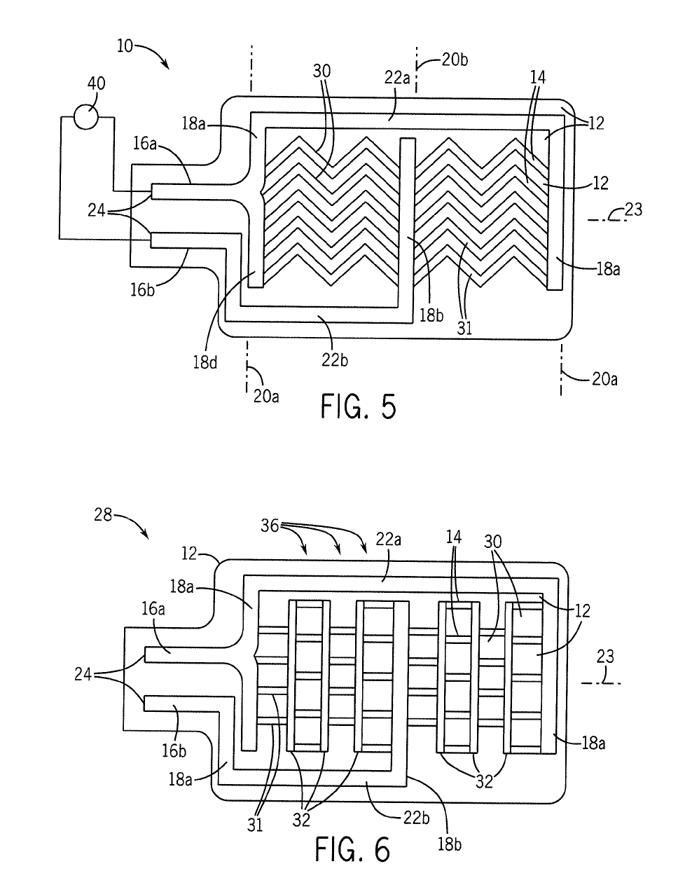

Referring now to FIG. 5, in the first embodiment of the invention, a high-voltage thick film polymer heater 10 may be constructed that alters the configuration of the PTC material 14 between fingers 18. This alteration (e.g., between fingers 18a and 18b) introduces current-isolating moats 30 into the PTC material 14 across which current may not flow. The isolating moats 30 may be created, for example, by removing the PTC material 14 and exposing the substrate 12 in the region of the isolating moats 30. The moats 30 may extend continuously between the flanking adjacent fingers 18 or part of the way. Generally the moats 30 will have a longitudinal length measured along the longitudinal axis 23 at least five times greater than the transverse height of the moats 31 measured perpendicularly to the longitudinal axis.

The isolating moats 30 extend generally along the longitudinal current flow axis 23 and as a result enforce a local direction of current flow generally along axis 23. The isolating moats 30 may be spaced periodically in a direction perpendicular to the longitudinal current flow axis 23 over the PTC material 14 to create many distinct conductive traces 31 of PTC material extending along the axis 23. In this embodiment, the traces 31 of the PTC material may be of substantially uniform width (perpendicular to the longitudinal current flow axis 23) traveling in a zigzag (non-linear) path parallel to axis 23.

As noted, the isolating moats 30, enforce substantially independent lines of current flow along axis 23 and prevent current from converging upon, for example, a region of crossover of axis 20 between heating areas 26 shown in FIG. 4. It should be noted that in this embodiment, the number of fingers 18 has been greatly reduced without sacrificing evenness of heating presenting a possible saving in conductive material of the fingers 18. In other aspects, the thick film polymer heater 10 may be analogous to thick film polymer heater 10. This embodiment may operate at a voltage between 330 volts DC and 1000 volts DC and has been shown to provide improved thermal uniformity at voltages within that range.

Referring now to FIG. 6, in an alternative embodiment, a series of floating bus bars 32 may be placed between and parallel to each pair of fingers 18a and 18b and evenly spaced therebetween. Importantly, the floating bus bars 32 are not electrically connected to the bus conductors 22 or to the fingers 18 or to each other. The floating bus bars 32 may generally extend perpendicularly to the path of current flow and span multiple traces 31 of PTC material 14. These floating bus bars 32 serve to provide a transverse redistribution of current among traces 31 of PTC material 14 across the moats 30 between the traces 31 in a direction perpendicular to longitudinal current flow axis 23. The material of the floating bus bars 32 will generally be identical to materials of the bus conductors 22 and fingers 18 having much lower resistance than the PTC material 14. The floating bus bars 32 may bridge the moats 31 or may overlie PTC material 14 and in doing so essentially conduct current away from that covered PTC material 14.

In this embodiment the moats 30 and the traces 31 between each of the floating bus bars 32, or floating bus bars 32 and fingers 18, may be staggered in a transverse direction perpendicular to longitudinal current flow axis 23 so that the traces 31 of PTC material 14 in a given row 36 (each row being between a given set of floating bus bars 32 or floating bus bars 32 and fingers 18) connects with the traces 31 in an adjacent row 36 only by means of floating bus bars 32 or fingers 18 and not by direct connection of PTC material 14. In this way the possibility of hotspots resulting from direct current flow between traces 31 in different rows 36 without moderation by the floating bus bars 32 is greatly reduced.

This embodiment may operate at a voltage between 330 volts DC and 1000 volts DC and has been shown to provide improved thermal uniformity at voltages within that range.

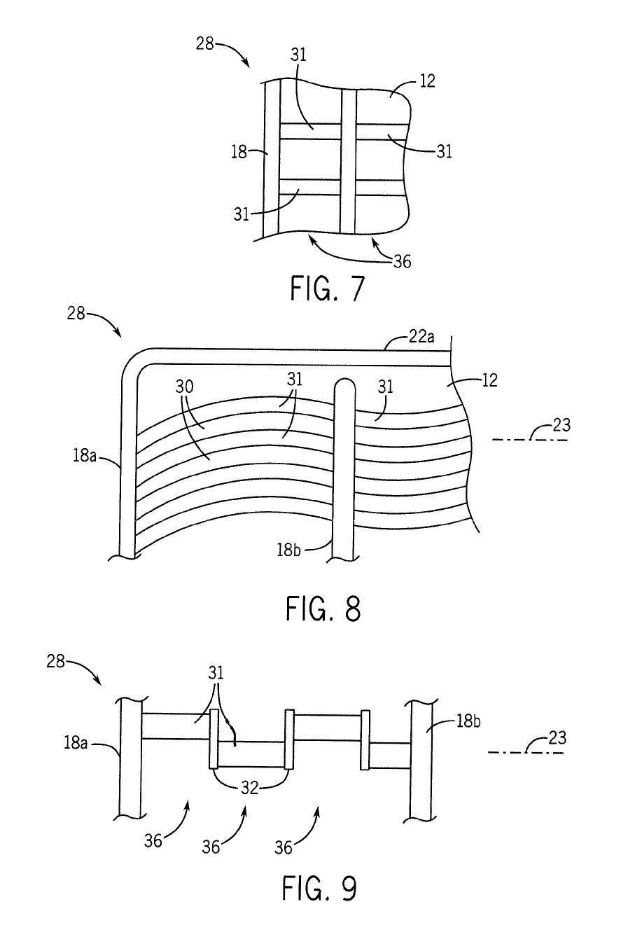

Referring now to FIG. 7, it will be appreciated that the thick film polymer heater 10 of FIG. 6 may alternatively allow for alignment and direct connection of PTC traces 31 between rows 36. This version relies upon the fingers 18 or floating bus bars 32 to redistribute current and to avoid hotspots at bridges between these traces 31 which may be possible to provide a good connection between the traces 31, and the lower resistance material of the floating bus bars 32 is ensured, for example, by adequate contact area.

Referring now to FIG. 8, it will be appreciated that the zigzagging PTC material 14 of traces 31 of FIG. 5 may take on a variety of other non-rectilinear shapes including a smooth sinusoidal-like pattern extending parallel to axis 23. These undulating patterns that nevertheless proceed on average along the longitudinal axis 23 will collectively be termed “serpentine”. Traces 31 may also be straight and parallel to axis 23.

Referring now to FIG. 9, in an alternative embodiment, floating bus bars 32 may be divided along their length perpendicular to axis 23 into segments, where each segment connects only a limited number of PTC traces 31 of different rows 36 (for example, one PTC trace 31 in a first row 36 may connect to only one PTC trace 31 in the second row 36 as shown) to further prevent current migration perpendicular to longitudinal current flow axis 23.

These various techniques may be combined, for example, with the traces 31 of FIG. 4 also spanned by floating bus bars 32 of the type shown in FIG. 5 evenly spaced between fingers 18a and 18b but parallel to those fingers 18.

Generally resistance refers to either bulk resistance or aerial resistance or both as context requires.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

All of the publications described herein, including patents and non-patent publications, are hereby incorporated herein by reference in their entireties.

What is claimed is:

1. A heater panel for a battery comprising:
a flexible polymer substrate;
conductive electrodes communicating between heater terminals and electrode fingers spaced apart along a longitudinal axis; and
a positive temperature coefficient material having a higher resistance than the conductive electrodes and electrically interconnecting and extending between the electrode fingers, the positive temperature coefficient material having a plurality of insulating moats blocking current flow through the positive temperature coefficient material across the moats, the moats positioned and sized to favor the flow of electrical current along the longitudinal axis through the positive temperature coefficient material in comparison to electrical current flow perpendicular to the longitudinal axis through the positive temperature coefficient material.

2. The heater panel for a battery of claim 1 wherein the moats are gaps in the positive temperature coefficient material having a longitudinal length measured along the longitudinal axis at least five times greater than a transverse height of the moats measured perpendicularly to the longitudinal axis.

3. The heater panel for a battery of claim 1 wherein the moats extend continuously between flanking pairs of electrode fingers.

4. The heater panel for a battery of claim 2 wherein the positive temperature coefficient material between each electrode finger is separated by a plurality of transversely spaced moats overlapping at each longitudinal position.

5. The heater panel for a battery of claim 4 wherein the plurality of transversely spaced moats is at least five moats.

6. The heater panel for a battery of claim 5 wherein the moats follow a serpentine path along the longitudinal axis.

7. The heater panel for a battery of claim 1 further including floating electrodes extending transversely across the positive temperature coefficient material in a transverse range in which portions of the positive temperature coefficient material is separated by moats.

8. The heater panel for a battery of claim 7 wherein the floating electrodes bridge at least one moat.

9. The heater panel for a battery of claim 1 further including an electrochemical cell attached to the flexible polymer substrate for thermal communication therewith and containing at least one flexible anode and cathode plate and at least one flexible outer polymer wall.

10. The heater panel for a battery of claim 1 further including a voltage source communicating with the heater terminals providing a voltage of greater than 50 volts.

11. The heater panel for a battery of claim 1 wherein the positive temperature coefficient material is a conductive ink.

12. The heater panel for a battery of claim 1 wherein the conductive electrodes are conductive ink having a lower resistance than the positive temperature coefficient material.

13. The heater panel for a battery of claim 1 wherein the resistance between the terminals is from 500-10 K ohms at ambient temperature.

14. A method of heating battery packs having multiple cell pouches comprising:
attaching to each cell pouch a heater panel having:
a flexible polymer substrate;
conductive electrodes communicating between heater terminals and electrode fingers spaced apart along a longitudinal axis;
a positive temperature coefficient material having a higher resistance than the conductive electrodes and electrically interconnecting and extending between the electrode fingers, the positive temperature coefficient material having a plurality of insulating moats blocking current flow through the positive temperature coefficient material across the moats, the moats positioned and sized to favor the flow of electrical current along the longitudinal axis through the positive temperature coefficient material in comparison to electrical current flow perpendicular to the longitudinal axis through the positive temperature coefficient material; and
applying a voltage of greater than 50 volts to the heater panel to heat each cell pouch.
